(19) United States
(12) Patent Application Publication
(10) Pub. No.: US 2013/0245959 A1
(43) Pub. Date: Sep. 19, 2013

(54) Computer-Implementable Algorithm for Biomarker Discovery Using Bipartite Networks

(71) Applicant: Board of Regents, The University of Texas System, (US)

(72) Inventors: Suresh K. Bhavnani, Galveston, TX (US); Kevin E. Bassler, Houston, TX (US); Shyam Visweswaran, Pittsburgh, PA (US)

(73) Assignee: Board of Regents, The University of Texas System, Austin, TX (US)

(21) Appl. No.: 13/827,632

(22) Filed: Mar. 14, 2013

Related U.S. Application Data
(60) Provisional application No. 61/610,887, filed on Mar. 14, 2012.

(51) Int. Cl. G06F 19/12

(52) U.S. Cl. CPC G06F 19/12
USPC 702/19

(57) ABSTRACT

An algorithm is disclosed for analyzing a bipartite network. The algorithm (1) progressively identifies a subset of bipartite networks that contain only those biomarkers that can separate the network into modules containing significantly different proportions of the subpopulation, and (2) outputs trends of key parameters to enable the researcher to analyze how the networks were identified. The algorithm outputs should for example enable biomedical researchers to rapidly identify key biomarkers, and infer the underlying biological mechanisms implicated in a wide range of diseases.

### CROSS-REFERENCE TO RELATED APPLICATIONS

This is a non-provisional filing of U.S. Provisional Patent Applicant Ser. No. 61/610,887, filed Mar. 14, 2012 (the '887 application), which is incorporated by reference and to which priority is claimed.

### STATEMENT REGARDING GOVERNMENT INTERESTS

This work was supported in part by the following United States Government grants:

| Federal Agency: | Award No.: |
|---|---|
| CDC/NIOSH | R21OH009441-01A2 |
| NIH/NCRR | UL1RR029876 |
| NIH/NLM | HHSN276201000030C |
| NSF/DMR | DMR-0908286 |

The Government may have certain rights in this invention.

### FIELD OF THE INVENTION

This disclosure relates to computer-implementable algorithms for finding significant patterns in large bipartite networks.

### BACKGROUND

Numerous biomedical researchers worldwide employ biomarker discovery to identify the molecular basis of biological states such as the onset of disease in humans. A biomarker is a measurable substance in an organism (e.g., gene expression level, protein amount, metabolite concentration, genomic sequence variation) which is used as an indicator for the risk, occurrence, or progression of disease, or as a predictor of response to therapy. Biomarker discovery is the analytical process through which biomarkers that differentiate between biological states (e.g., disease versus healthy, early disease versus advanced disease) are identified from data. An important goal of biomarker discovery is to enable biomedical researchers to infer the underlying biological mechanisms that produce the biological state of interest. For example, if the proteins Interleukin-4 and Eotaxin are highly expressed in a set of cases (e.g., asthma subjects) compared to controls (e.g., healthy subjects), a researcher may infer that the molecular mechanism underlying asthma involves Interleukin-4 and Eotaxin.

The data used in biomarker discovery typically consists of measurements for multiple molecular entities in cases (e.g., subjects with disease) and controls (e.g., healthy subjects), and this is shown graphically in FIG. 1A in one example. Shown in the network 10 of FIG. 1A are 1410 subjects who are distributed among two subpopulations. Each subject either belongs to the diseased subpopulation (i.e., is a case) or the healthy subpopulation (i.e., is a control). Also shown are 100 biomarkers that in this example are single nucleotide polymorphisms (SNPs) which are variations at specific locations in the DNA sequence across subjects. The subjects and biomarkers comprise “nodes” in the network 10. A line or an “edge” between a subject and a SNP denotes that the subject has a variant nucleotide at that SNP; conversely, the absence of an edge indicates that the subject has the normal nucleotide at that SNP. As would be expected in a network 10 as large as this, each subject may be connected to many SNPs, and each SNP may be connected to many subjects.

Network 10 of FIG. 1A is known as a bipartite network; such a network contains two types of nodes (e.g., subject nodes and biomarker nodes) and edges exist only between a subject node and a biomarker node. Furthermore, network 10 is an un-weighted bipartite network, because the presence or absence of an edge between a subject and a SNP simply denotes whether the subject does, or does not have a variant nucleotide at that SNP. In the more complicated example of a weighted bipartite network, an edge represents the degree of a relationship between the subject and the biomarker. For example, if the biomarker is a protein, an edge in a weighted network could represent the amount of that protein in the corresponding subject.

FIG. 1B shows the raw data 20 used to generate the network 10 of FIG. 1A, and as shown such raw data 20 can be embodied in a typical spreadsheet program such as Excel™ or a mathematical analysis program such as Matlab™. As shown, the raw data 20 comprises many rows of subjects, the second column indicates if the subject is a case (‘1’) or a control (‘2’), and the remaining columns indicate in binary fashion whether a particular subject has a variant nucleotide at a SNP (‘1’) or not (‘0’).

As is typical, and as shown in FIG. 1C, the raw data 20 can be stored as a file in a computer system 15, such as a typical desktop computer or other computing device, system or network. This raw data 20 can be stored with or made accessible to the computer system 15 in any number of well-known manners, including entry by keyboard, or by loading the raw data 20 into the computer system by disk, memory stick, wirelessly, from the Internet or other network, etc. Computer system 15 would comprise at least one processor for performing necessary calculations on the raw data 20, as one skilled in the art understands.

In generating the graphical representation of the network 10 in FIG. 1A from the raw data 20 shown in FIG. 1B, a force-directed algorithm is used. As is known, force-directed algorithms are a class of algorithms for drawing networks that reveal the relationship between the nodes in an aesthetically pleasing and informative way. Generally speaking, a force-directed algorithm positions the nodes (i.e., the subjects and the SNPs) in a two-dimensional or three-dimensional space by assigning forces to each node and pulling them closer together if they share relatively many edges, or pushing them further apart if they do not. This method is repeated iteratively until the system comes to an equilibrium state when node positions no longer change from one iteration to the next. The resulting layout is approximate, and designed to enable a researcher to quickly comprehend the overall relationship (clustered, nested, random, etc.) among the nodes. At this point, the network 10 is rendered, and as shown in FIG. 1C may be output from the computer system to an output device 40 such as a printer or display, or stored in the computer system 10 for later viewing. Examples of force-directed algorithms that are useful are the Fruchterman-Reingold and Kamada-Kawai algorithms. Further details concerning force-directed algorithms can be found in “Force-Based Algorithms (Graph Drawing),” which was submitted in the above incorporated '887 application.

Force-directed algorithms are useful in laying out bipartite networks because of their ability to group nodes of a network into clusters or “modules” if they exist, and thus perhaps reveal complex associations between the two types of nodes (subjects and biomarkers). A cluster or a module is defined as a set of nodes in the bipartite network that are more densely connected than nodes in different modules. A partitioning refers to dividing the nodes in the bipartite network into a set of modules, and such partitioning into modules can be done in several different ways, depending on the goals of the researcher. Such visualizations of bipartite networks can enable a biomedical researcher to analyze the relationships between the biomarkers, and across the subpopulations (cases and controls) in the different modules if they exist. Networks that are laid out using force-directed algorithms often enable rapid comprehension of complex biomarker and disease relationships, leading to the generation of hypotheses about underlying biological mechanisms.

Unfortunately, in the large network 10 of FIG. 1A, no clusters or modules are immediately apparent. Therefore, any association between the SNPs and the disease being investigated is not immediately apparent. Colloquially, network 10 can be called a “hairball” due to its apparently random layout of subject and SNP nodes.

The prior art has turned to various methods from statistics and machine learning to help identify statistically significant patterns in a complicated network such as 10. Current statistical and machine learning methods can be divided into supervised (e.g., chi-squared, logistic regression), and unsupervised learning methods (e.g., clustering, network visualization and analysis). For example, supervised learning methods can be used to rank biomarkers based on their degree of connection imbalance, as discussed further below, or to learn a statistical model from subject and biomarker data which can then be applied to new subjects to make disease predictions.

Connection imbalance quantifies the degree to which each biomarker is unequally connected to the subpopulations in the bipartite network, and is illustrated in the simple networks of FIG. 2A. SNP-A in the left network has a high connection imbalance because it is connected to a relatively higher number of cases compared to controls. In contrast, SNP-B in the right network has a low connection imbalance because it is connected to an equal number of cases and controls.

The degree of connection imbalance of each biomarker can be computed using Pearson's chi-squared test, which is a well-known statistical test of association between two or more nominal variables. For example, it can be used to test the association between a biomarker with categorical values (e.g., SNP present or SNP absent). By using a table where the columns and rows represent the variables being compared (e.g., a 2×2 table representing the biomarker state and disease state, with the cells representing the corresponding frequencies of values), a test of no association between the rows and columns is equivalent to a test of the null hypothesis that there is no association between the biomarker and the disease variable. Pearson's chi-squared test involves first determining the expected cell counts for each cell in the table assuming that the biomarker is not associated with the disease. For example, the expected count for the first cell E11=((n11+n21)×(n11+n12))/(n11+n12+n21+n22). Pearson's chi-squared statistic is given by:

$${\sum }_{i = 1}^{2} {\sum }_{j = 1}^{2} \frac{{( {O}_{ij} - {E}_{ij} )}^{2}}{{E}_{ij}}$$

where Oᵢⱼ is the count in the (i,j)-cell and Eᵢⱼ is the expected count in the (i,j)-cell. The above statistic has a chi-squared distribution with one degree of freedom.

| | SNP present | SNP absent |
|---|---|---|
| Diseased | n11 | n12 |
| Healthy | n21 | n22 |

Further details concerning this technique can be found in “Chi-Squared Distribution,” which was submitted in the above incorporated '887 application.

Of particular interest is the calculation of a “p-value” in chi-squared analysis, or what is referred to here as a “CI” (Connection Imbalance) value to differentiate this from other variables to be discussed later. CI for a SNP is the probability that the SNP is more strongly associated with either the cases or controls, compared to chance alone. In this circumstance, the null hypothesis is that a particular SNP is equally associated with the cases or controls, and therefore not of much value in distinguishing the cases from the controls. Higher degrees of connection imbalance result in lower CI values, and thus the null hypothesis is typically rejected when CI is less than some threshold (CI(t)), indicating the statistically significant result that a SNP does in fact strongly associate with either the cases, or with the controls, (hence the term “connection imbalance”). A typical p-value threshold in chi-squared statistic can be <0.05, although the use of even lower thresholds is useful in the context of the network 10 of FIG. 1A.

Other statistical methods can also be used to compute connection imbalance, and there are a wide range of univariate (e.g., p-values from chi-squared) or multivariate (e.g., standard error from logistic regression) techniques that can be used.

FIG. 2B shows the resulting CI values for each of the SNPs in network 10. Such CI values can be calculated in the computing system 15, and perhaps using the same program that holds the raw data 20 (i.e., Excel™ or Matlab™). Once calculated, the results can be sorted or ranked in the computing system 15 as shown to the right in FIG. 2B. This technique reveals that SNP lab_rs429358 seems to be most significantly associated to the disease. SNPs rs4420638 and rs3732443 also appear significant, although less so than lab_rs429358. Other SNPs with CI values higher than 0.05 would appear to be irrelevant in the disease process at hand (and may already have been removed from the data set). Armed with this knowledge, the researcher can focus efforts on trying to understand the biological mechanism of lab_rs429358, rs4420638, and rs3732443, and perhaps other SNPs going down the ranked list, in the disease process at hand. This understanding can possibly lead to the development of suitable therapies, such as drug or genetic therapies.

However, the ranked list of SNPs in FIG. 2B neither represents the relationship they have to each other, nor shows the relationships between SNPs and the subpopulations of subjects, thereby compromising the ability of researchers to infer the underlying biological mechanisms which requires both types of information simultaneously to make informed inferences. This is significant, because it is known that many disease processes do not turn simply on a single SNP, but on a combination of SNPs. For example, it could be the case that the strongest indicator of disease in network 10 is in subjects that have a combination of SNPs. Assume for example that rs7964760 and rs118429, when both expressed in a given subject, are highly relevant in the disease process. These SNPs, viewed in isolation in FIG. 2B, are the fourth and eighth most relevant in the ranked list. Because such relationships among the SNPs are simply not represented in the technique of FIG. 2B, such association between these two lower-ranked SNPs might be easily overlooked. Furthermore, the above SNPs could be strongly associated with mainly control subjects, which would indicate that this combination of SNPs is protective against the disease of interest and provides a different hypothesis of the underlying biological mechanism than if, for example, the SNPs were strongly associated with mainly case subjects.

To understand such complex bipartite associations in biomedical data, a better solution is therefore warranted, and is disclosed herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A illustrates a force-directed network that models associations between subjects and certain biomarkers for a given disease process; FIG. 1B shows the data for the above network; and FIG. 1C shows the computer system in which such a network can be analyzed and generated.

FIG. 2A illustrates simple networks introducing the concept of connection imbalance; and FIG. 2B illustrates a prior art biomarker discovery process in which connection imbalance is used to rank potentially relevant biomarkers.

FIG. 3 illustrates an embodiment of an improved algorithm for biomarker discovery.

FIGS. 4A and 4B illustrate simple networks introducing the concepts of modularity and module imbalance used in the improved algorithm of FIG. 3.

FIGS. 5A-5C illustrate the force-directed networks output by the improved algorithm at different stages of its operation.

FIG. 6 illustrates a graph of certain parameters that vary during the operation of the algorithm.

FIG. 7 illustrates a modification to the improved algorithm.

### DETAILED DESCRIPTION

An algorithm is disclosed for analyzing a bipartite network. The algorithm progressively identifies a subset of bipartite networks that contain only those biomarkers that can separate the network into partitions containing significantly different proportions of the subpopulation. Compared to the hairball illustrated earlier, the disclosed technique should enable biomedical researchers to rapidly infer the underlying biological mechanisms implicated in a wide range of diseases.

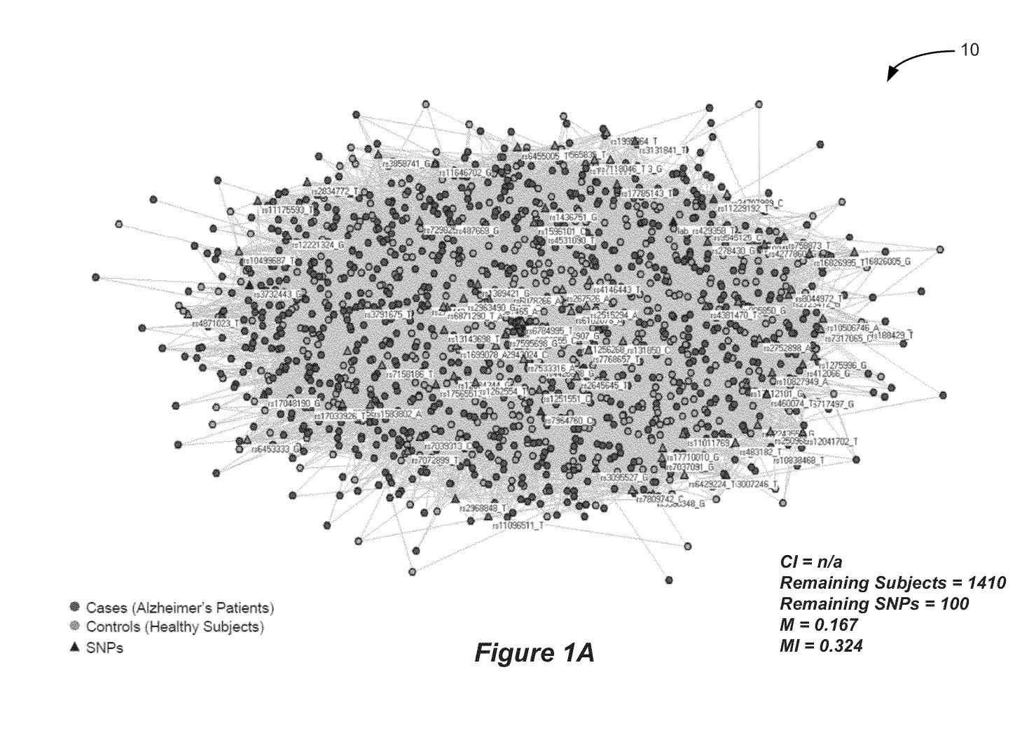

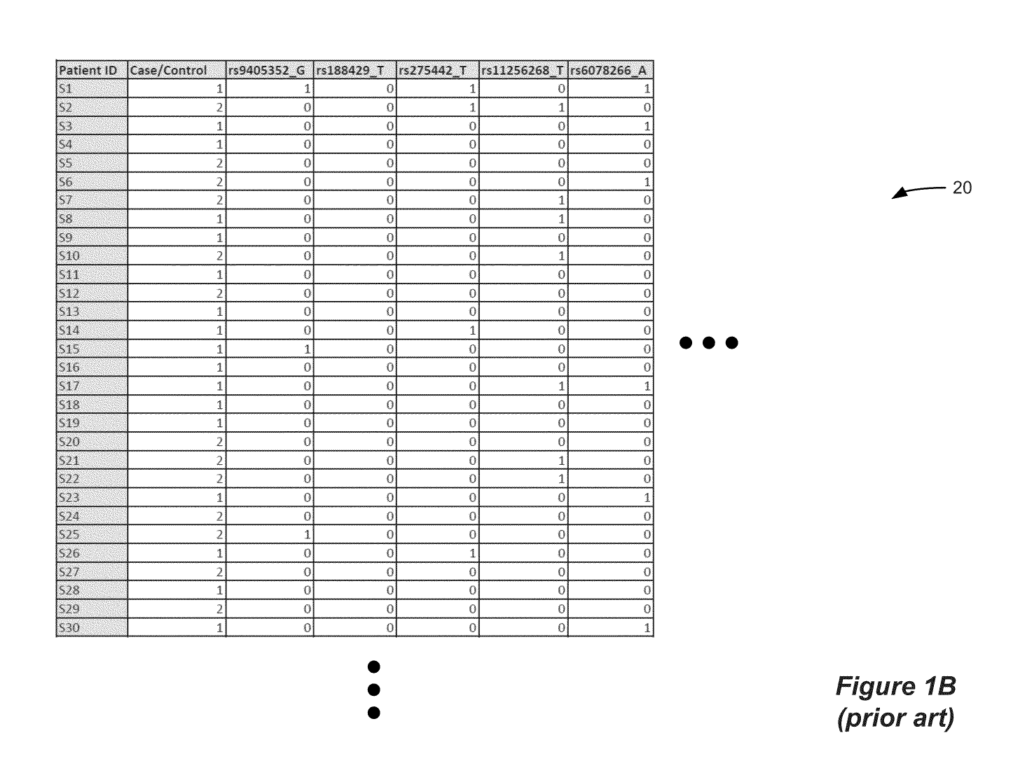

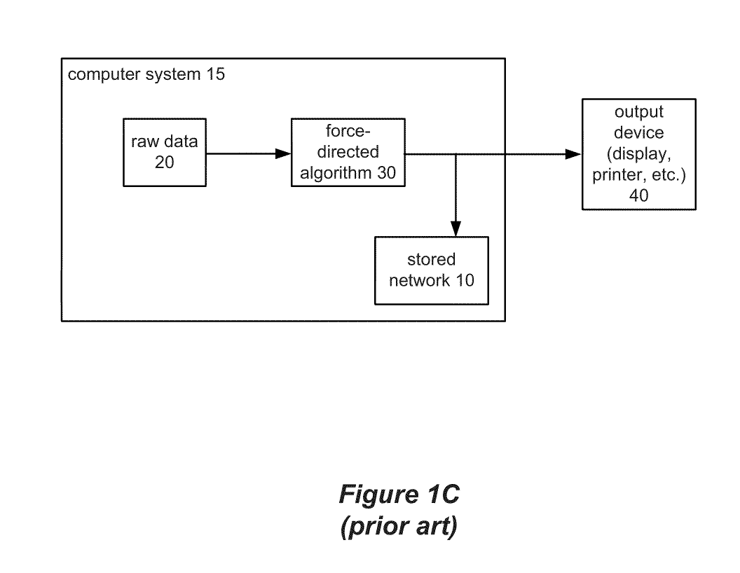

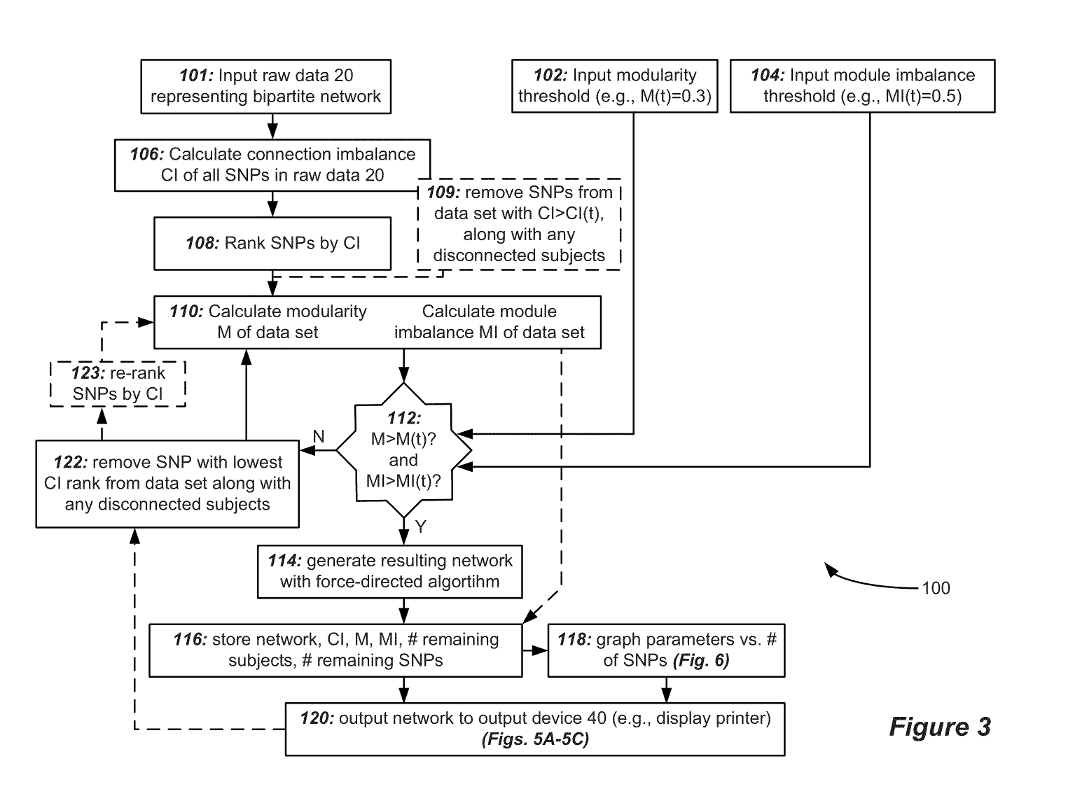

The improved algorithm 100 for biomarker discovery is shown in FIG. 3, which can run on computer system 15 (FIG. 1C). The algorithm 100 uses three separate measurements: connection imbalance, partitioning, and partition imbalance. FIG. 3 depicts an exemplary algorithm utilizing modularity and modularity imbalance for partitioning and partition imbalance measurements. Thus, measurements in FIG. 3 include connection imbalance (CI); modularity (M); and module imbalance (MI).

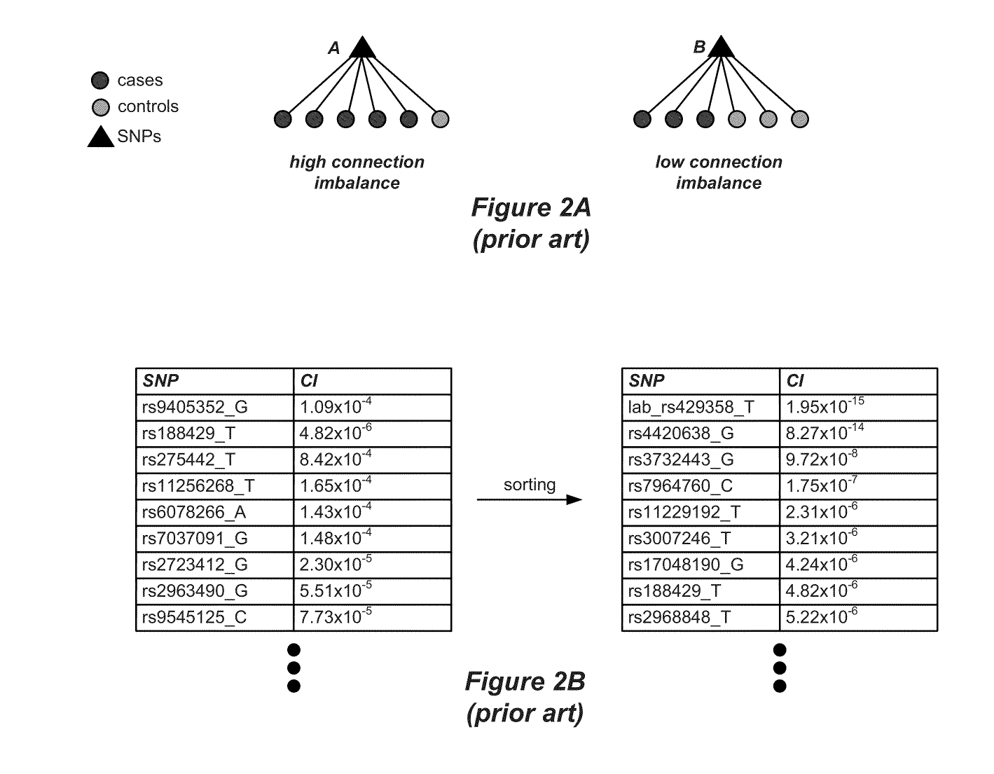

Connection imbalance, which was previously discussed with reference to FIGS. 2A and 2B, is the property of a single biomarker. And as previously discussed, connection imbalance can be computed by a variety of quantitative methods known in the art including p-values from chi-squared, the t-test statistic, and standard error from logistic regression techniques. Connection imbalance could also be computed using a combination of approaches to achieve an aggregate ranking strategy. Additional or alternative ranking strategies can also be employed such as graph-based methods (e.g., betweenness centrality).

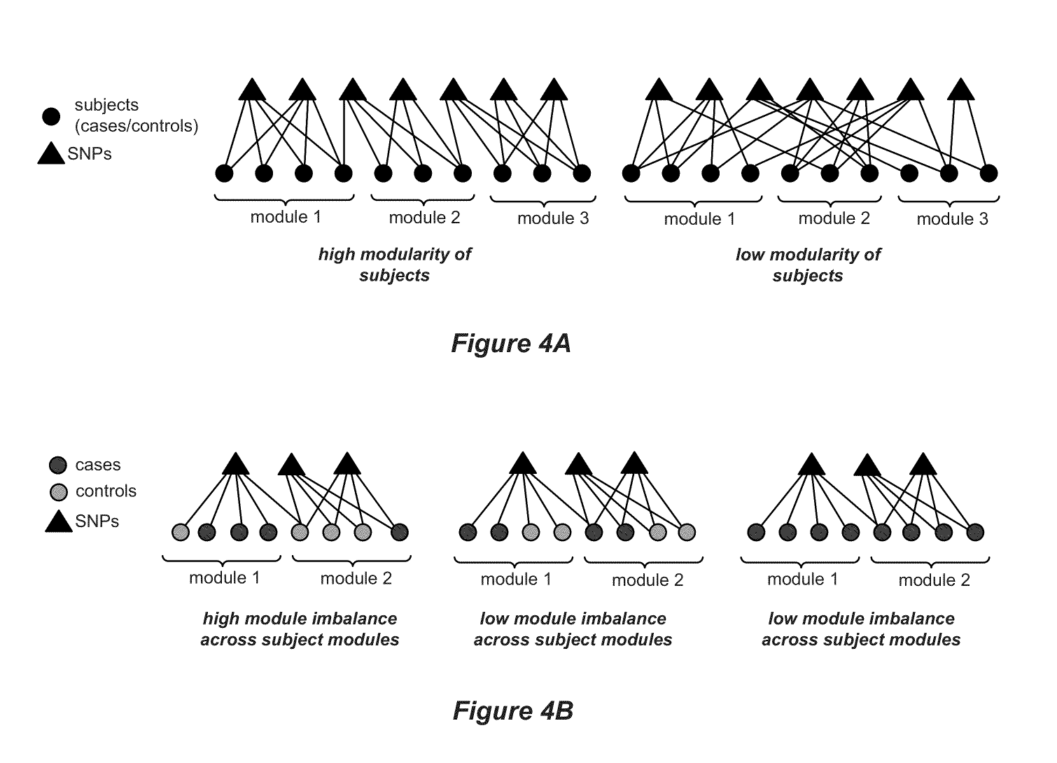

Partitions, on the other hand, are properties of an entire network. Partitioning can be accomplished using one or more techniques including, but not limited to: modularity, connectivity-based clustering (e.g., hierarchical clustering), centroid-based clustering (e.g., k-means clustering), distribution-based clustering (e.g., multivariate normal distributions), and density-based clustering. FIG. 3 depicts an algorithm using modularity and module imbalance to demonstrate an exemplary partitioning technique. Although modularity is used to exemplify one form of partitioning in the description below, it will be understood that the algorithm could additionally or alternatively use any form of partitioning. Qualitative and quantitative discussions of modularity and module imbalance are discussed below in some detail with reference to FIGS. 4A and 4B before returning to the particulars of the algorithm 100.

FIG. 4A illustrates the concept of modularity (M). For an unweighted unipartite network, the modularity M of a given partitioning of the nodes into modules is defined as the fraction of edges that occur between nodes within the defined modules, minus the expected fraction if the edges were distributed randomly. The modularity of the network corresponds to maximum modularity of all possible partitionings.

There are a number of ways to extend this concept to bipartite networks. The options include finding modules that include both types of nodes (subjects and SNPs), referred to as bi-clustering, and finding modules in just one of the sets of nodes (e.g., either SNPs or subjects). In the latter option, the bipartite net is projected onto a unipartite net with only the nodes of the one set for which the clustering is sought. For unweighted bipartite networks, one way to do this is to project the bipartite network onto a unipartite multigraph in which pairs of subject nodes are connected with as many edges as the number of SNPs they are both connected to in the bipartite graph. In this case, the modularity M(P) of a partitioning P that divides the subject nodes of the network into modules is defined as:

$$M ( P ) = {\sum }_{i , j} {B}_{ij} {δ}_{C ( i ) , C ( j )}$$

where indices i and j run over all subject nodes, C(i) is the module that node i belongs to in partitioning P, δ is the Kronecker delta, and Bᵢⱼ is an element of the Modularity matrix and is defined as

$${B}_{ij} = \frac{{c}_{ij}}{{\sum }_{a} {m}_{a} ( {m}_{a} - 1 )} - \frac{{t}_{i} {t}_{j}}{{( {\sum }_{s} {m}_{a} )}^{2}}$$

where index a runs over all SNP nodes, cᵢⱼ is the number of SNP nodes that subject node i and subject node j are both connected to, t, is the total number of edges connected to subject node i, and mₐ is total number of edges connected to SNP node a. Note that B is a real symmetric matrix and, as such, has real eigenvalues and eigenvectors. In this formula, in the limit of a sparse network, the sum over the first term of the elements of the Modularity matrix is the fraction of projected edges that occur between nodes within a module, and the second term is the expected fraction if the projected edges were randomly placed.

The modularity of the network M is the maximum modularity of all possible partitionings. Thus, in principle, when calculating M all possible partitionings should be considered. However, this is often not possible because of the large number of possible partitions. Approximate solutions are, thus, typically used. An approximate solution that can be obtained by considering an optimized subset of the possible partitionings.

One way to obtain such an approximate solution is to find an approximate modularity maximizing partitioning through an iterative bisectioning process that first considers partitioning the set of nodes into two modules, and then proceeds by iteratively considering further partitioning each module into two modules, etc. The process continues until no partitioning with larger modularity is found. The initial bisectioning can be done by first making a guess at the best partitioning and then refining the guess. This guess can be made by finding the eigenvector corresponding to the largest positive eigenvalue of the Modularity matrix, and then assigning the nodes corresponding to positive elements of this leading eigenvector to one module and the rest of the nodes to the other module. The leading eigenvector can be obtained using, for example, the power method.

This guess at the best bisectioning can be improved using Kernighan-Lin tuning, such as is described in “Kernighan-Lin Algorithm,” which is submitted herewith and incorporated herein by reference in its entirety. Kernighan-Lin tuning systematically considers moving each node from its current module into the other to see if there is an improvement in modularity. The node whose movement results in the largest modularity is first found and temporarily assigned to its new module. Its assignment is then assumed fixed. This process is iteratively repeated on the remaining non-fixed nodes until the movement of each node has been considered. Throughout this process, after each node is chosen for movement the intermediate partitioning giving the largest improvement in modularity is stored. If there is more than one intermediate partitioning giving the same largest improvement then all are stored and one is chosen at random. If the stored partitioning has smaller modularity than the guess, then the tuning stops and the guess is used for the partitioning. Otherwise the guess is replaced with the stored partitioning and the whole tuning process is repeated until there is no longer an improvement in modularity.

After the initial bisectioning of the nodes, the bisectioning process is iteratively repeated on each subset. However, to avoid overcounting, the quantity that should be maximized when bisectioning module Ck is the modularity difference

$$Δ {M}^{k} ( P ) = {\sum }_{i , j ∈ {C}_{k}} {B}_{ij}^{k} {δ}_{C ( i ) , C ( j )}$$

where B^{k}ᵢⱼ is defined as

$${B}_{ij}^{k} = {B}_{ij} - {δ}_{ij} {\sum }_{l ∈ {C}_{k}} {B}_{il} .$$

A bisectioning modularity maximizing algorithm can be further improved if a generalization of Kernighan-Lin tuning, known as final tuning, is also used. Final tuning, like Kernighan-Lin tuning, systematically considers moving each node from its current module to see if there is an improvement in modularity. However, in final tuning, all nodes of the network are simultaneously tuned by considering moving each node into any other module or into a new, previously empty module. It is best to use final tuning each time after a loop in which every existing module has been bisectioned.

The output of this analysis is the computed modularity of the network M, the number of identified modules, and the members of each module, without taking into consideration the attributes of nodes such as the case/control differentiation of the subjects. However, it should be noted that module definition and a computation of the modularity of a bipartite network can be determined in other manners as well, and that the foregoing should be understood as merely one way of making these determinations. As stated previously, finding the partitioning that maximizes modularity is but one of the known ways to partition a network into clusters or modules. Other methods have their own quantitative measure of significance for clustering. The disclosed algorithm 100 can be used with any such modularity techniques. See also Roger Guimerà et al., “Module identification in bipartite and directed networks,” Physical Rev. E 76, 036102 (2007), which was submitted in the above incorporated '887 application.

To reiterate, the modularity of the network is the maximum modularity of all possible partitionings. A value of M>M(t)=0.3 is generally considered as an indication of substantial modularity. FIG. 4A shows example bipartite networks that respectively do, and do not, have substantial modularity. Both networks have 10 subject nodes, and seven SNP nodes. In both figures, the clustering of the subject nodes with maximum modularity is shown, as well as the resulting modules giving rise to that maximum modularity, and in both cases three modules are identified. However, in the left network there are substantially more edges between nodes in the same module than between nodes in different modules, yielding a relatively high modularity value M=0.51, whereas in the right network there are not substantially more edges between nodes in the same module than between nodes in different modules, yielding a relatively low modularity value M=0.19.

FIG. 4B illustrates module imbalance, which like modularity is based upon the modules in the network. Unlike connection imbalance, which quantifies the degree of connection between a biomarker and a subpopulation of subjects (cases and controls), module imbalance relates to the content of the modules of subjects in the network as identified by the modularity algorithm described above. Generally speaking, module imbalance represents the degree to which the proportion of cases and controls is different between the modules in the bipartite network. For example, the network to the left in FIG. 4B has high module imbalance because module 1 has a high proportion of cases versus controls, whereas module 2 has a high proportion of controls versus cases. Because this cases-to-control proportion differs substantially between the two modules, module imbalance in the network is high. By contrast, the network in the center of FIG. 4B has low module imbalance (or high module balance) because module 1 and module 2 both have identical proportions of cases and controls. Finally the network to the right in FIG. 4B shows a special case in which all subjects are cases in both modules resulting again in low module imbalance (or high module balance).

Module imbalance can be calculated with Cramér's V, and further details concerning this technique can be found in “Cramér's V,” which was submitted in the above incorporated '887 application. Cramér's V is a measure of association between two nominal variables, and is calculated using the following formula:

MI≡V=√(χ²/(n×(k−1))),

where χ² is the chi-square statistic of the proportion of cases and controls across the modules, n is the total number of subjects in the current model, and k is the smaller of the number of rows and number of columns in the chi-square contingency table (which is the input to the chi-square statistic discussed earlier). MI ranges from 0 to 1, where 0-0.1 represents little imbalance (i.e., the modules have similar proportions of cases and controls), 0.1-0.3 represents low imbalance, 0.3-0.5 represents moderate imbalance, and >0.5 represents high imbalance (i.e., where the modules have very different proportions of cases and controls).

With the concepts of connection imbalance, modularity, and module imbalance so introduced, discussion now returns to FIG. 3 to illustrate how these different measurements are put to use in the improved algorithm 100. Generally speaking, the algorithm 100 seeks to iteratively remove SNPs that are relatively non-discriminatory between cases and controls from the raw data 20 based on CI, and then to compute both the modularity (M) and module imbalance (MI) of the resulting data set to test if modules with significantly different proportions of cases and controls exist. The goal of the algorithm 100 is that, as the SNPs are progressively removed, it identifies resulting networks with both high modularity and high module imbalance, which can potentially provide important information for inferring the underlying biological mechanisms involved in the cause or prevention of the disease.

The algorithm 100 starts using the same bipartite-network raw data 20 discussed in the prior art (step 101), and as before, connection imbalance CI is calculated for each biomarker (step 106), and these CI values are ranked (step 108), similar to the earlier illustration of FIG. 2B.

Next, both the modularity (M) and module imbalance (MI) are calculated on data set (step 110), with such calculations occurring as discussed above. The resulting M and MI values are compared to their selected thresholds (e.g., M(t)=0.3; MI(t)=0.5), which are input in the computer system 15 at steps 102 and 104) to test if the calculated values are both above the respective thresholds (step 112). If either is below the selected thresholds, then the process repeats and the SNP with the lowest CI ranking (i.e., the SNP with the highest CI value from step 108) is removed from the data set (step 122). Additionally removed from the data set are any subjects who no longer have any connection to the remaining SNPs (i.e., “disconnected subjects”). As these subjects had connections only to the removed SNPs which are relatively non-discriminatory between the cases and controls, the disconnected subjects do not contain the requisite information to decipher the mechanisms involved in the disease.

With this lowest-ranked SNP and disconnected subjects removed, the algorithm 100 returns to step 110 to recalculate M and MI on the now-smaller data set, and once again the M and MI values are compared to their thresholds (step 112). If either threshold is not met, the now lowest-ranked SNP (i.e., the second-lowest-ranked SNP as originally ranked) is removed along with any disconnected subjects (122), and so on until the thresholds for M and MI are met.

The SNP removal step 122 is described above as removing one SNP at a time, but the removals can be alternatively or additionally be performed by removing groups of less significant SNPs in sets (3, 5, 10, etc., at a time) or by using significance cut-offs (e.g., removal of all SNPs with CI greater than 0.00005 or 5×10⁻⁵). In some embodiments, the removal steps can be conducted in a narrowing fashion such that the groups of deleted SNPs become smaller as the threshold values are approached.

Once the thresholds are met (step 112), the remaining data set is processed with a force-directed algorithm (step 114) to generate a displayable network in an output device 40 (e.g., display or printer) as described earlier (step 120). In addition, the network data is stored in the computer system 15 along with other parameters including, e.g., the CI, M, and MI values, the number of disconnected subjects, and/or the number of SNPs remaining in the data set (step 116),

It can be assumed at this point that the resulting network may reveal associations of interest for a researcher to review. However, even more relevant associations may start to occur as more and more SNPs are removed, and so as shown in FIG. 3, the algorithm can continue removing SNPs and disconnected subjects (122), recalculating M and MI (110), and comparing the thresholds (112). If both thresholds are met again in the shrinking data set, the network can again be generated by the force-directed algorithm (114), stored (116), and outputted (120).

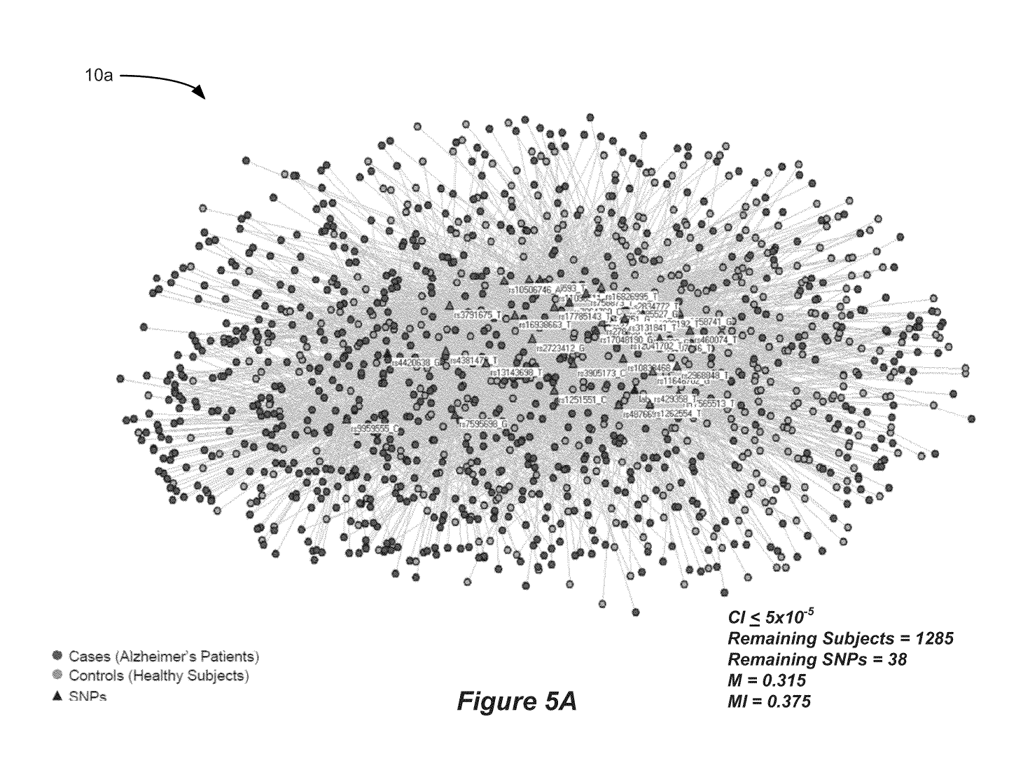

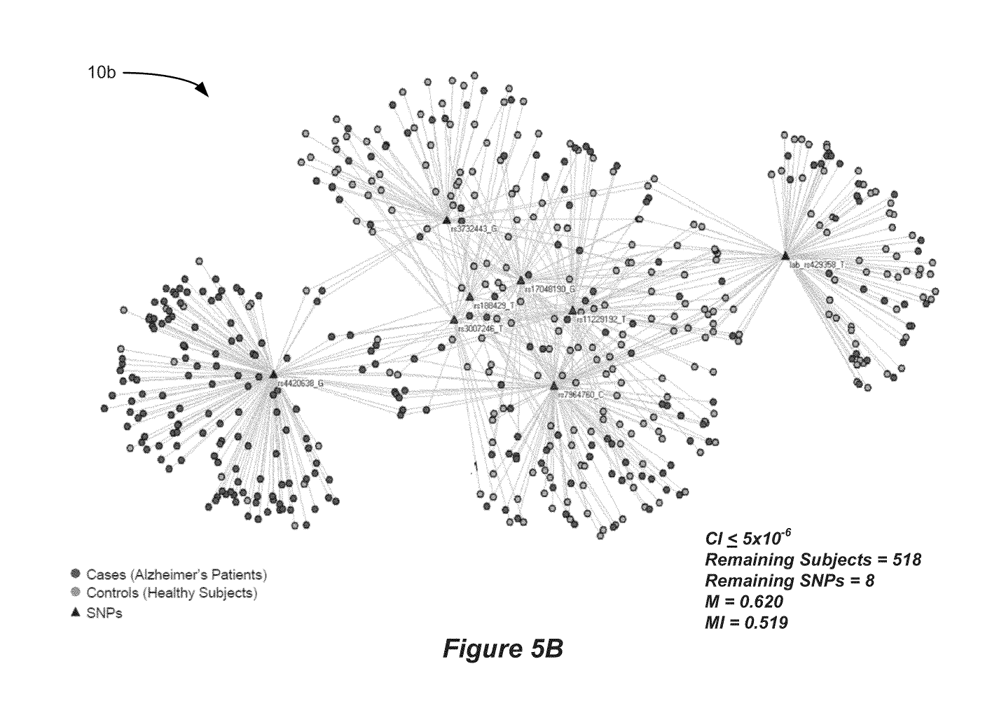

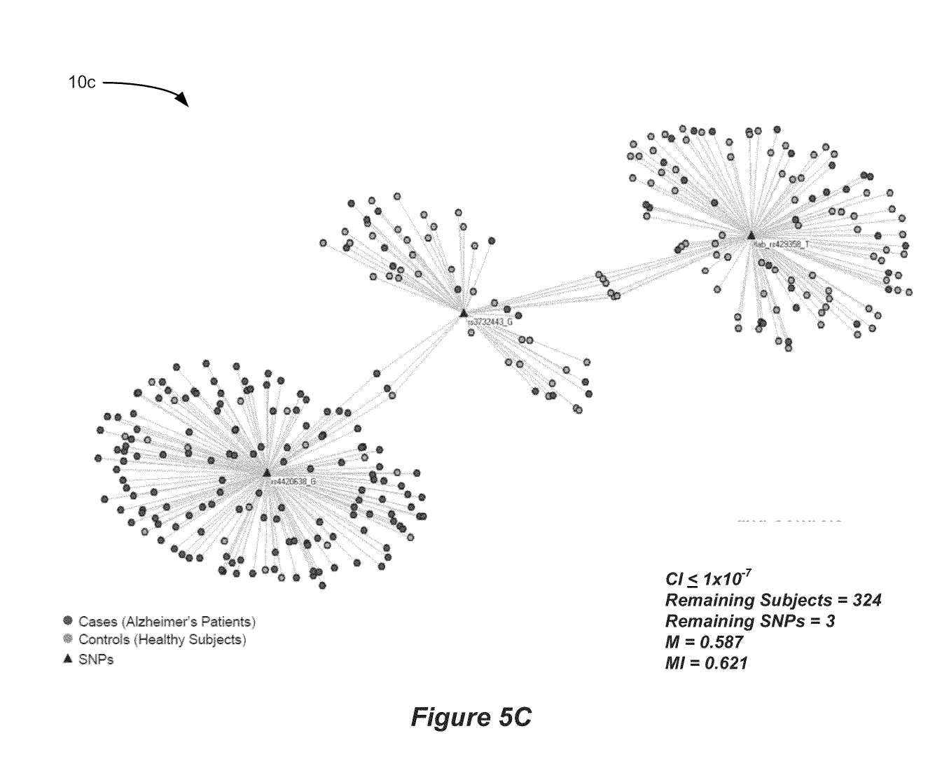

FIGS. 5A-5C illustrate progressive operation of the algorithm 100 as SNPs are removed from the network 10 and the raw data 20 shown in FIGS. 1A and 1B. In FIG. 5A, the algorithm 100 has progressed to the point where all SNPs with CI values greater than 5×10⁻⁵ have been removed, which in the example data shown equates to the 38-most-relevant SNPs remaining (That is, 62 SNPs and their disconnected subjects have been removed in step 122). The resulting network 10a doesn't visually indicate a high degree of modularity at this stage, let alone any potential module imbalance. This is reflected in the low values for M (0.315) and MI (0.375) for network 10a, i.e., not very substantial modularity or module imbalance.

In FIG. 5B, the algorithm 100 has progressed to the stage where all SNPs with CI values greater than 5×10⁻⁶ have been removed, which in the example data shown equates to the 8-most-relevant SNPs remaining (That is, 92 SNPs and their disconnected subjects have been removed in step 122). The resulting network 10b at this point is starting to indicate some clustering, and even qualitatively it can be noticed that some of the modules are starting to show a predominance of cases (on the left) or controls (on the right). This is reflected in the increased values for the M (0.620) and MI (0.519) for network 10b, both substantially high values compared to the thresholds discussed earlier.

When coupled with the layout generated by the force-directed algorithm, further important insights are derived from the network 10b of FIG. 5B, particularly concerning the relationship between the SNPs. Note for example that the modules in the middle predominantly consist of controls, which are related to six SNPs: rs3732443, rs7964760, rs11229192, rs3007246, rs17048190, and rs188429. This suggests that these six SNPs may bear some relationship to each other, and may operate in coordination in the disease being modeled in the network 10b. Notice that this fact is revealed even though these six SNPs were only the third to eighth most-seemingly relevant for consideration pursuant to the CI ranking provided by the prior art (see FIG. 2B). Because this prior art technique does not assess relationships between biomarkers, and cannot simultaneously reveal relationships between biomarkers and the subpopulations of subjects, the potential relevance of these six SNPs interacting with each other in a complex biological mechanism might be overlooked.

It is pertinent to note that in many biomedical datasets, a large number of biomarkers are typically significant between cases and controls. Therefore CI and associated measures on their own are often not sufficiently informative for knowing how many biomarkers to drop before the network is analyzed. For example, one could drop all but an arbitrarily small number of significant biomarkers to inspect, but such an approach relies on guessing or trial and error, and may result in the removal of important data that is potentially informative about the underlying biological mechanisms. In that respect, MI combined with M provide a systematic method to determine the minimum number of biomarkers to drop before inspecting the resulting network, resulting in the maximum preservation of data for a given threshold of MI and M. In FIG. 5C, the algorithm 100 has progressed to the point where all SNPs with CI values greater than 1×10⁻⁷ have been removed, which in the example data shown equates to the three most-relevant SNPs remaining (That is 97 SNPs and their disconnected subjects have been removed in step 122). The resulting network 10c at this point clearly indicates distinct modules, and it is easier to see the predominance of cases or controls in those modules, which can indicate to a researcher whether the SNPs related to a module are dangerous or protective. Again, this is reflected in the high values for M (0.87) and MI (0.621) values for network 10c.

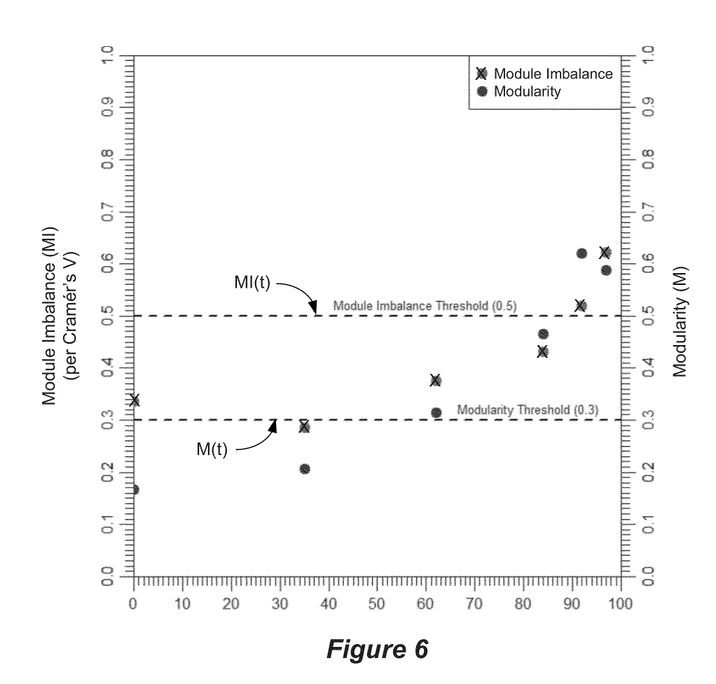

As noted earlier, certain parameters may be stored along with the force-directed network at step 116 of the algorithm 100, such as the connection imbalance (CI) of the remaining SNPs, modularity (M), module imbalance (MI), the number of disconnected subjects, and the number of remaining biomarkers (e.g., SNPs). Such parameters can optionally be plotted (FIG. 3, step 118) and output (120) as shown in FIG. 6 to understand how these parameters are trending during operation of the algorithm 100. While these parameters can be graphed in different ways, they are usefully plotted using the number of dropped biomarkers (SNPs) on the X-axis, and M and MI on the Y-axes. (The number or percentage of disconnected subjects could also be graphed, but this is not shown in FIG. 6). Superimposing the plots on one graph enables a comprehension of trends related to the plotted parameters with respect to each other. Also useful to plot are the thresholds M(t) and MI(t) that were input to the algorithm to comprehend how M and MI are trending with respect to the SNPs that are removed from the data set. Such trending can be used to gauge reasonable thresholds M(t) and MI(t) for the network at hand, and if necessary the algorithm can be rerun with more suitable values for M(t) and MI(t) as divined by the information in FIG. 6.

Tracking the number of disconnected subjects is useful to understand the rate at which the subjects are being dropped from the original raw data 20. This is important, because as the algorithm 100 runs and as SNPs and disconnected subjects are removed, the sample size of the network may eventually become too small to calculate M and MI reliably.

Because of the importance of the parameters as a function of removed SNPs, such parameters can be stored (step 116), graphed (118) and output (120) regardless whether the M and MI thresholds have been met (at step 112). Thus, FIG. 3 shows an optional by-passing of the threshold decision (step 112) and network generation (114) steps. In this manner, relevant parameters are captured for every iteration of the algorithm 100, but networks are only generated (114) and stored (116) when thresholds for M and MI are met. Such selective production of the networks is computationally efficient, as time and memory are not wasted in the computer system 15 generating networks that would be of dubious significance for a researcher to review.

While force-directed layouts of networks such as shown in FIG. 5A-5C and FIG. 6 are useful outputs of the algorithm 100, they are not the only means of outputting useful information.

Other modifications can be made to the algorithm 100 of FIG. 3. For example, optional step 109 initially removes SNPs and from the raw data that do not meet a connection imbalance threshold, CI(t). In other words, a certain number of the lowest ranked SNP (step 108) are initially removed right off the top. This again can be computationally efficient, as it can remove from the data set SNPs not likely to have any statistical significance, and which likely would have been successively removed from the data set in step 122 of the algorithm in any event. As noted earlier, a good threshold for connection imbalance significance is CI<CI(t)=0.05.

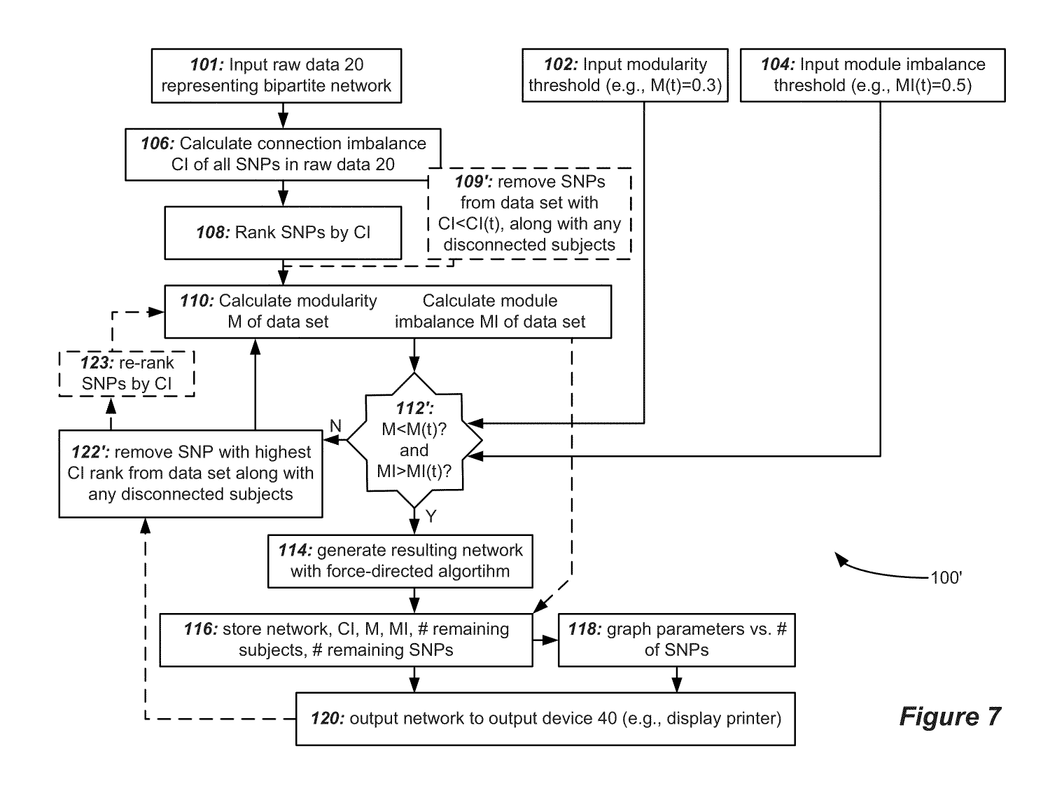

In another modification, the algorithm can discover biomarkers that result in balanced modules (instead of imbalanced modules as in the original algorithm 100). This modified algorithm 100′ is shown in FIG. 7. Algorithm 100′ only differs from algorithm 100 in a few respects. First, instead of the algorithm dropping biomarkers that have low CI rankings (i.e., high CIs), it drops biomarkers that have high CI rankings (i.e., low CIs) (steps 122′ and 109′). Second, instead of testing for MI greater than the selected threshold, the algorithm tests for MI to be below the threshold (step 112′) for a network to qualify for being saved for viewing through the force-directed algorithm. This embodiment is important for applications where high modularity in a network is important, but the content of the modules need to be balanced such as for balancing the proportion of races in different groups of subjects.

In another modification, the algorithm can re-rank the biomarkers at each iteration (step 123; FIGS. 3 and 7) after one or more biomarkers have been dropped and subjects disconnected (steps 122 and 122′). This would exclude the disconnected subjects from the calculation of CI, which could result in a different ranking of the resulting biomarkers.

Even though the algorithm 100 was illustrated using two different subpopulations of subjects (cases and controls), it should be understood that the algorithm is general and therefore can be used to analyze any number of categories in a bipartite network. For example, subpopulations of “early disease,” “moderate disease,” and “advanced disease,” could also be assessed using the Cramér's V formula. This feature of the algorithm is an important improvement over many traditional methods which are restricted to only two outcomes. The biomarkers to be discovered are also not limited to SNPs, but could comprise any measurable biological feature. For example, in addition to SNP data, the nodes could additionally or alternatively include phenotypic, demographic, and/or symptomatic data. In fact, the disclosed algorithm is not limited to analyzing only networks in the medical domain, but is applicable to the analysis of any bipartite relationship, and as such can be used to reveal associations in a wide range of complex bipartite data representing potential causes of conditions in network data points.

The algorithm 100 can also work with weighted bipartite networks, which as noted earlier are those in which the edges can represent a continuum of values. In such networks, instead of using chi-square to measure CI based on binary inputs, t-test or other statistical methods designed to calculate a significance value for continuous values can be used. Furthermore, if the condition being analyzed is continuous (e.g., disease stages ranging on a scale of 1-10) rather than being binary (e.g., disease versus healthy), then the module imbalance can be calculated based on methods such as ANOVA and Kruskal-Wallis designed to test the difference across groups using continuous values. Further details concerning these techniques can be found in “Analysis of Variance,” and “Kruskal-Wallis One-way Analysis of Variance,” which are submitted herewith and incorporated herein by reference in their entireties.

The algorithm 100 can be embodied in a computer-readable medium, such as a single medium or multiple media (e.g., a centralized or distributed database, and/or associated caches and servers) that store instructions for execution by a machine, such as the computer system 15 disclosed earlier. Examples of computer-readable media include, but are not limited to, solid-state memories, or optical or magnetic media such as discs. Algorithm 100 can also be implemented in digital electronic circuitry, in computer hardware, in firmware, in special purpose logic circuitry such as an FPGA (field programmable gate array) or an ASIC (application-specific integrated circuit), in software, or in combinations of them, which again all comprise examples of “computer-readable media.” When implemented as software fixed in computer-readable media, such software can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Although particular embodiments of the present invention have been shown and described, it should be understood that the above discussion is not intended to limit the present invention to these embodiments. It will be obvious to those skilled in the art that various changes and modifications may be made without departing from the spirit and scope of the present invention. Thus, the present invention is intended to cover alternatives, modifications, and equivalents that may fall within the spirit and scope of the present invention as defined by the claims.

What is claimed is:

1. A method for analyzing potential associations in a data set, comprising:
(a) receiving the data set at a computer system, wherein the data set comprises a plurality of data points each represented by one of a plurality of conditions, a plurality of potential causes of those conditions, and selective connections between the plurality of data points and the plurality of potential causes;
(b) calculating in the computer system for each potential cause a connection imbalance which quantifies the degree to which each potential cause is unequally connected to the plurality of conditions;
(c) calculating in the computer system
(i) a partitioning of the data set which quantifies the degree to which the data points and potential causes are clustered into partitions by the selective connections, and
(ii) a partition imbalance in the data set which quantifies the degree to which the proportion between conditions is different between the partitions in the data set;
(d) comparing the partitioning and the partition imbalance to thresholds;
(e) if step (d) indicates either low partitioning or low partition imbalance, removing at least one potential cause with the lowest connection imbalance from the data set, and returning to step (c); and
(f) if step (d) indicates both high partitioning or high partition imbalance, processing the data set with a force-directed algorithm in the computer system to produce a graphical network.

2. The method of claim 1, further comprising outputting the graphical network to an output device coupled to the computer system.

3. The method of claim 1, wherein step (e) further comprises removing from the data set any data points that are no longer connected to any potential cause after the at least one potential cause is removed.

4. The method of claim 1, wherein step (e) further comprises re-calculating connection imbalance before returning to step (c).

5. The method of claim 1, wherein the plurality of conditions are categorical.

6. The method of claim 1, wherein the plurality of conditions are continuous.

7. The method of claim 1, wherein the selective connections between the plurality of data points and the plurality of potential causes are weighted.

8. The method of claim 1, wherein the plurality of potential causes comprise biomarkers, and wherein the data points represent subjects.

9. The method of claim 8, wherein the plurality of conditions represent a state of disease.

10. The method of claim 1, further comprising:
(g) after step (f), removing at least one potential cause with the lowest connection imbalance from the data set, and returning to step (c).

11. The method of claim 1, wherein calculating the connection imbalance comprises the use of the chi-squared statistic if the connections are un-weighted, and the t-test statistic if the connections are weighted.

12. The method of claim 1, wherein the partitioning is modularity, and the partition imbalance is module imbalance.

13. The method of claim 12, wherein calculating the module imbalance comprises the use of Cramér's V measure of association when the conditions are categorical, and ANOVA and Kruskal Wallis when the conditions are continuous.

14. A method for analyzing potential associations in a data set, comprising:
(a) receiving the data set at a computer system, wherein the data set comprises a plurality of data points each represented by one of a plurality of conditions, a plurality of potential causes of those conditions, and selective connections between the plurality of data points and the plurality of potential causes;
(b) calculating in the computer system for each potential cause a connection imbalance which quantifies the degree to which each potential cause is unequally connected to the plurality of conditions;
(c) calculating in the computer system
(i) the modularity of the data set which quantifies the degree to which the data points and potential causes are clustered into modules by the selective connections, and
(ii) the module imbalance in the data set which quantifies the degree to which the proportion between conditions is different between the modules in the data set;
(d) storing at least the number of potential causes, the modularity, and the module imbalance;
(e) removing at least one potential cause with the lowest connection imbalance from the data set, and returning to step (c); and
(f) plotting either or both of the stored modularity and module imbalance as a function of a number of potential causes in the data set.

15. The method of claim 14, wherein step (e) further comprises removing from the data set any data points that are no longer connected to any potential cause after the at least one potential cause is removed.

16. The method of claim 14, wherein the plurality of conditions are categorical.

17. The method of claim 14, wherein the plurality of conditions are continuous.

18. The method of claim 14, wherein the plurality of potential causes comprise biomarkers, and wherein the data points represent subjects.

19. The method of claim 18, wherein the plurality of conditions represent a state of disease.

20. The method of claim 14, further comprising after step (c), processing the data set with a force-directed algorithm in the computer system to produce a graphical network.
